(19) United States
(12) Patent Application Publication
(10) Pub. No.: US 2015/0175029 A1
(43) Pub. Date: Jun. 25, 2015

(54) APPARATUS FOR AIR CONDITIONING BATTERY FOR VEHICLES

(71) Applicant: Hyundai Motor Company, Seoul (KR)

(72) Inventors: Man Ju OH, Yongin-si (KR); Jae Woong Kim, Hwaseong-si (KR); Jae Woo Park, Ansan-si (KR); Jae Hoon Kim, Cheonan-si (KR)

(73) Assignee: Hyundai Motor Company

(21) Appl. No.: 14/328,214

(22) Filed: Jul. 10, 2014

(30) Foreign Application Priority Data
Dec. 19, 2013 (KR) 10-2013-0159541

(51) Int. Cl. B60L 11/18; F25B 21/02

(52) U.S. Cl. CPC B60L 11/1874; F25B 21/02

(57) ABSTRACT

An air-conditioning system for an automotive battery includes a heat exchanger composed of a heat-absorbing pipe and a heat-discharging pipe, which partially overlap with each other, and a thermoelectric element interposed in the overlapping portion. A battery housing accommodates a battery and in which an end of the heat-absorbing pipe of the heat exchanger is inserted.

### CROSS-REFERENCE(S) TO RELATED APPLICATION

The present application claims the benefit of priority to Korean Patent Application Number 10-2013-0159541 filed on Dec. 19, 2013, the entire contents of which application is incorporated herein for all purposes by this reference.

### TECHNICAL FIELD

The present disclosure relates to an air-conditioning system for an automotive battery which is a closed system and stable and compact using a thermoelectric cooler.

### BACKGROUND

The present disclosure relates to an air-conditioning system for a high-voltage battery of electric vehicles and hybrid vehicles which keeps the high-voltage battery in the optimum state by increasing/decreasing a temperature of the high-voltage battery.

Environmental-friendly vehicles such as the electric vehicles, the hybrid vehicles, and fuel cell vehicles use a motor and the high-voltage battery for driving. The high-voltage batteries are disposed where they cannot show their performance and may be deteriorated due to overcharging in charging or other necessary cases and overcooling in winter. Accordingly, a technology capable of effective air-conditioning for those high-voltage batteries is necessary.

In the related art, air-conditioning systems using existing refrigerants are used to cool batteries in most cases using convection by taking cooled air in vehicles and sending it to the batteries. This technology, however, causes a load for cooling the interior to increase and cannot heat the batteries, if necessary, when the interior is being cooled.

On the other hand, in a battery cooling/heating structure that performs both cooling and heating, using a peltier component (thermoelectric cooler), a peltier heat exchanger is disposed on a side of a high-voltage battery and fins for discharging waste heat to the outside of the battery. The battery cooling/heating structure has is an air-to-air structure of reducing discharging heat when discharging the waste heat.

The description provided above as a related art of the present disclosure is just for helping in understanding the background of the present disclosure and should not be construed as being included in the related art known by those skilled in the art.

### SUMMARY OF THE DISCLOSURE

The present disclosure has been made in an effort to provide an air-conditioning system for an automotive battery which is a closed system and stable and compact, using a thermoelectric cooler.

According to an exemplary embodiment of the present disclosure, an air-conditioning system for an automotive battery includes a heat exchanger composed of a heat-absorbing pipe and a heat-discharging pipe, which partially overlap with each other and a thermoelectric cooler interposed in the overlapping portion. A battery housing accommodates a battery, and an end of the heat-absorbing pipe of the heat exchanger is inserted in the battery housing.

An internal blower, which allows air in the battery housing to exchange heat with the end of the heat-absorbing pipe, may be disposed in the battery housing.

An exhaust duct may be connected to an end of the heat-discharging pipe.

An external blower, which discharges heat from the heat-discharging pipe may be disposed in the exhaust duct.

The battery housing may accommodate the battery in its closed internal space.

Both the internal blower and the external blower may be operated in cooling and only the internal blower may be operated in heating.

The heat exchanger may include the heat-absorbing pipe that transmits heat from one end portion to the other end portion. A pair of thermoelectric coolers are disposed on both sides of the other end portion of the heat-absorbing pipe, respectively, with the heat-absorbing sides in contact with the heat-absorbing pipe. A pair of heat-discharging pipes are disposed with end portions in contact with the heat-discharging sides of the pair of thermoelectric coolers. Heat-exchanging members are disposed on one end portion of the heat-absorbing pipe and the other end portions of the heat-discharging pipes, respectively.

One end portion of the heat-discharging pipe may be disposed lower than the other end portions and may be connected with the thermoelectric cooler.

According to the air-conditioning system for an automotive battery which has the structure described above, it is possible to provide an air-conditioning system for the automotive battery which is a closed system and is stable and compact, using the thermoelectric cooler.

### BRIEF DESCRIPTION OF THE DRAWINGS

The above and other features of the present disclosure will now be described in detail with reference to certain exemplary embodiments thereof illustrated by the accompanying drawings which are given hereinbelow by way of illustration only, and thus are not limitative of the present disclosure.

FIG. 1 is a view showing an air-conditioning system for an automotive battery according to an embodiment of the present disclosure.

FIGS. 2 and 3 are views showing a heat exchanger of an air-conditioning system for an automotive battery according to an embodiment of the present disclosure.

It should be understood that the appended drawings are not necessarily to scale, presenting a somewhat simplified representation of various preferred features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Exemplary embodiments of the present disclosure are described hereafter with reference to the accompanying drawings.

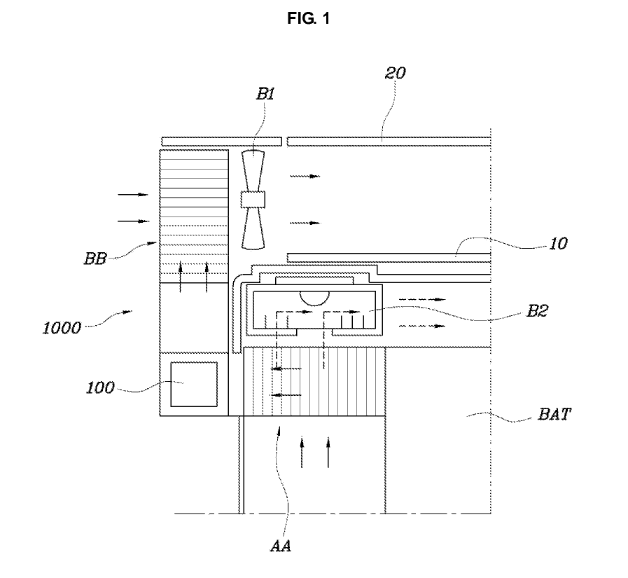

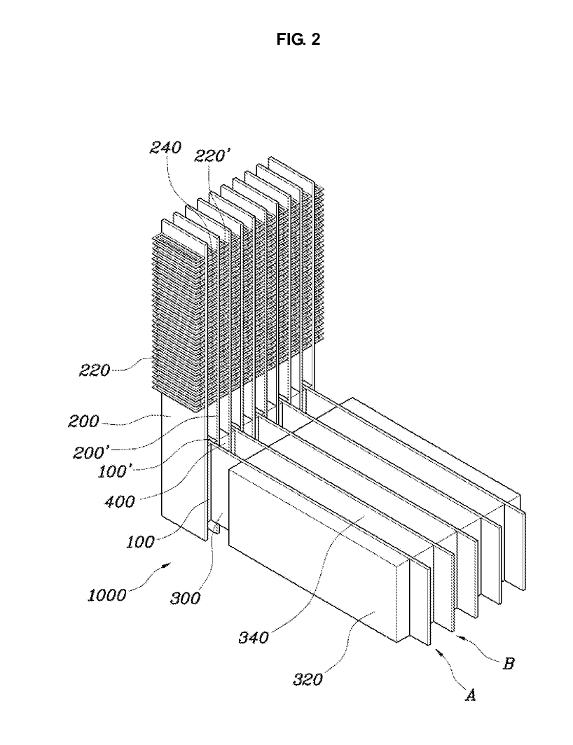

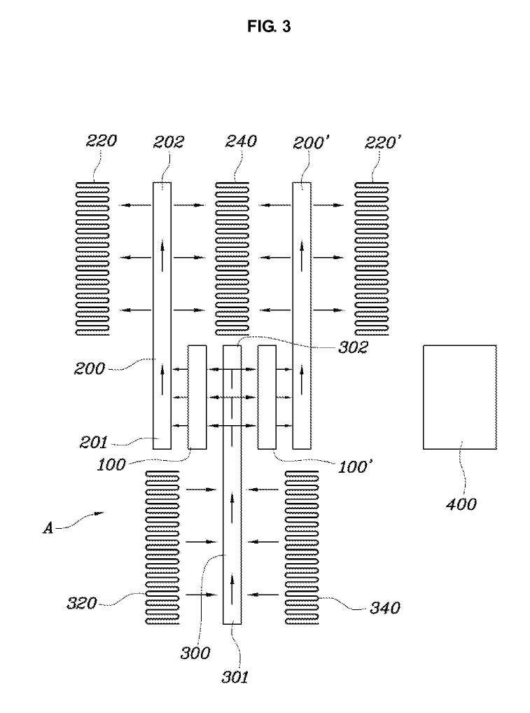

FIG. 1 is a view showing an air-conditioning system for an automotive battery according to an embodiment of the present disclosure. FIGS. 2 and 3 are views showing a heat exchanger of the air-conditioning system for the automotive battery according to an embodiment of the present disclosure.

An air-conditioning system for an automotive battery according to the present disclosure includes a heat exchanger 1000 composed of a heat-absorbing pipe 300 and a heat-discharging pipe 200, which partially overlap with each other, and a thermoelectric cooler 100 interposed in the overlapping portion. A battery housing 10 accommodates a battery BAT, and in which an end of the heat-absorbing pipe 300 of the heat exchanger is inserted.

The heat exchanger is described first with reference to FIGS. 2 and 3. The heat exchanger 1000 having thermoelectric coolers includes a heat-absorbing pipe 300 that transmits heat from one end portion 301 to the other end portion 302. A pair of thermoelectric elements 100 and 100′ are disposed on both sides of another end portion 302 of the heat-absorbing pipe 300, respectively, with the heat-absorbing sides in contact with the heat-absorbing pipe 300. A pair of heat-discharging pipes 200 and 200′ are disposed with end portions 201 in contact with the heat-discharging sides of the thermoelectric coolers 100 and 100′. Heat-exchanging members 400 are disposed on one end portion 301 of the heat-absorbing pipe 300 and the other end portions of the heat-discharging pipes 200 and 200′, respectively.

The thermoelectric coolers 100 and 100′ absorb and discharge heat from one side to the other side when electricity is applied, so one side functions as a heat-absorbing side and the other side functions as a heat-discharging side. When the heat exchanger is provided with the thermoelectric coolers 100 and 100′, performance of the heat exchanger particularly depends on how well the heat-discharging sides discharge heat in cooling. Accordingly, the heat exchanger using the thermoelectric coolers requires a larger area or weight at the heat-discharging side than the heat-absorbing side.

To this end, the heat exchanger having the thermoelectric coolers includes the heat-absorbing pipe 300 that transmits heat from one end portion 301 to the other end portion 302, the pair of thermoelectric coolers 100 and 100′ disposed on both sides of the end portion 302 of the heat-absorbing pipe 300, respectively, with the heat-absorbing sides in contact with the heat-absorbing pipe 300. The pair of heat-discharging pipes 200 and 200′ are disposed with the end portions 201 in contact with the heat-discharging sides of the thermoelectric coolers 100 and 100′. The heat-exchanging members 400 are disposed on the end portion 301 of the heat-absorbing pipe 300 and the other end portions 202 of the heat-discharging pipes 200 and 200′, respectively.

The heat-absorbing pipe 300 transmits heat from the end portion 301 to the other end portion 302. The thermoelectric coolers 100 and 100′ are disposed on both sides of the other end portion 302 of the heat-absorbing pipe 300. One of the thermoelectric elements 100 and 100′ receives heat from the heat-absorbing pipe 300 and discharges the heat through both heat-discharging sides.

The pair of heat-discharging pipes 200 and 200′ are disposed with the end portions 201 in contact with the heat-discharging sides of the thermoelectric coolers 100 and 100′. Accordingly, the heat is absorbed through one heat-absorbing pipe 300, but is discharged through the pair of thermoelectric coolers 100 and 100′ and the pair of heat-discharging pipes 200 and 200′, such that efficiency increases.

Further, the heat-exchanging members 400 are disposed on the end portion 301 of the heat-absorbing pipe 300 and the other end portions 202 of the heat-discharging pipes 200 and 200′ in order to exchange heat. The heat-absorbing pipe 300 and the heat-discharging pipes 200 and 200′ may be plates and the heat-exchanging members 400 may be heat-exchanging fins.

As shown in detail in FIG. 3, the other end portion 301 of the heat-absorbing pipe 300 may be disposed at least at the same positions or a higher position than the end portion 302. Accordingly, heat rises and transfers upward and it is efficient. Similarly, the pair of heat-discharging pipes 200 and 200′ are arranged opposite to each other, and the other end portions 202 of the heat-discharging pipes 200 and 200′ may be disposed at least at the same positions or the higher position than the end portions 201.

The heat-exchanging fins as the heat-exchanging members 400 may be disposed in contact with both sides of the end portion 301 of the heat-absorbing pipe 300. The heat-exchanging fins as the heat-exchanging members 400 are disposed in contact with both sides of the other end portions 202 of the heat-discharging pipe 200 and 200′, and the adjacent heat-discharging pipes 200 and 200′ can share the heat-exchanging fins therebetween.

FIG. 2 shows the entire structure and heat-exchanging modules A each of which includes the heat-absorbing pipe 300 that transmits heat from one end portion 301 to the other end portion 302, the pair of thermoelectric elements 100 and 100′ disposed on both sides of the end portion 302 of the heat-absorbing pipe 300, respectively, with the heat-absorbing sides in contact with the heat-absorbing pipe 300. The pair of heat-discharging pipes 200 and 200′ are disposed with end portions 201 in contact with the heat-discharging sides of the thermoelectric elements 100 and 100′. The heat-exchanging members 400 are disposed on the end portion 301 of the heat-absorbing pipe 300 and the other end portions of the heat-discharging pipes 200 and 200′ and may be continuously arranged in parallel in the heat exchanger having the thermoelectric coolers 100.

A heat-exchanging member 400 may be disposed between opposite sides of the end portions 201 of the adjacent heat-discharging pipes 200 and 200′, in between the adjacent heat-exchanging modules A and B. Accordingly, in the heat-discharging part, adjacent thermoelectric coolers and heat-discharging pipes are thermally connected, respectively, so efficiency is increased with an increase in weight.

The adjacent heat-exchanging modules A and B can share the heat-exchanging members 400 between the opposite sides of one end portion of a heat-absorbing pipe. Further, the adjacent heat-exchanging modules A and B can share the heat-exchanging members 400 between the opposite sides of the other end portion of a heat-discharging pipe. Therefore, heat exchange efficiency increases.

According to the heat exchanger with thermoelectric coolers which are formed in the structure described above, it is possible to increase the performance and efficiency of the thermoelectric elements as much as possible, to freely install the heat-discharging part, and to reduce the manufacturing cost by sharing the heat-discharging fins.

The air-conditioning system for an automotive battery according to the present disclosure uses the heat exchanger 1000 and includes a heat exchanger 1000 composed of heat-absorbing pipes 300 and a heat-discharging pipe 200, which partially overlap with each other, and a thermoelectric element 100 interposed in the overlapping portion. A battery housing 10 accommodates a battery BAT and in which an end of the heat-absorbing pipe 300 of the heat exchanger 1000 is inserted.

An internal blower B2 that allows the air in the battery housing to exchange the heat with the end portion of the heat-absorbing pipe may be provided in the battery housing 10. Accordingly, the air in the battery housing is conditioned while exchanging the heat with the end portion of the heat-absorbing pipe by the operation of the internal blower B2. The part AA, shown in FIG. 1, is the heat-absorbing side and shows the heat-absorbing pipe, and the part BB is the heat-discharging side and shows the heat-discharging pipe. It is apparent that the functions of absorbing and discharging heat may change in accordance with a polarity direction of the thermoelectric coolers.

An exhaust duct 20 may be connected to the end of the heat-discharging pipe 200. An external blower B1 that discharges heat from the heat-discharging pipe may be provided in the exhaust duct 20. The battery housing 10 may accommodate a battery BAT in its closed internal space. Accordingly, the air-conditioning efficiency increases.

In the cooling of the battery, both the internal blower B2 and the external blower B1 are operated, and the heat-absorbing pipe absorbs the heat in the battery housing by electric operation of the thermoelectric cooler. Further, the heat is discharged to the outside through the heat-discharging pipe. In the heating of the battery, external heat is supplied into the battery housing, the heat is absorbed in the heat-discharging pipe, and the heat is discharged through the end of the heat-absorbing pipe. Accordingly, it is possible to operate only the internal blower B2 in heating.

One end of the heat-discharging pipe is disposed lower than the other end and connected with the thermoelectric cooler to discharge the heat well in cooling.

According to the air-conditioning system for an automotive battery which has the structure described above, it is possible to provide an air-conditioning system for an automotive battery which is a closed system and is stable and compact, using the thermoelectric cooler.

Although the present disclosure was described with reference to specific embodiments shown in the drawings, it is apparent to those skilled in the art that the present disclosure may be changed and modified in various ways without departing from the scope of the present disclosure, which is described in the following claims.

What is claimed is:

1. An air-conditioning system for an automotive battery, comprising:
a heat exchanger composed of a heat-absorbing pipe and a heat-discharging pipe, which partially overlap with each other, and a thermoelectric cooler interposed in the overlapping portion; and
a battery housing that accommodates the battery and in which an end of the heat-absorbing pipe of the heat exchanger is inserted.

2. The air-conditioning system of claim 1, wherein an internal blower that allows air in the battery housing to exchange heat with the end of the heat-absorbing pipe is disposed in the battery housing.

3. The air-conditioning system of claim 1, wherein an exhaust duct is connected to an end of the heat-discharging pipe.

4. The air-conditioning system of claim 3, wherein an external blower that discharges heat from the heat-discharging pipe is disposed in the exhaust duct.

5. The air-conditioning system of claim 1, wherein the battery housing accommodates the battery in its closed internal space.

6. The air-conditioning system of claim 1, wherein both the internal blower and the external blower are operated in cooling and only the internal blower is operated in heating.

7. The air-conditioning system of claim 1, wherein the heat exchanger includes:
the heat-absorbing pipe that transmits heat from one end portion to the other end portion;
a pair of thermoelectric coolers disposed on both sides of the other end portion of the heat-absorbing pipe, respectively, with the heat-absorbing sides in contact with the heat-absorbing pipe;
a pair of heat-discharging pipes disposed with one end portions in contact with the heat-discharging sides of the pair of thermoelectric coolers; and
heat-exchanging members disposed on one end portion of the heat-absorbing pipe and the other end portions of the heat-discharging pipes, respectively.

8. The air-conditioning system of claim 7, wherein one end portion of a heat-discharging pipe is disposed lower than the other end portion and is connected with a thermoelectric cooler.
